(19) United States
(12) Patent Application Publication
(10) Pub. No.: US 2008/0256716 A1
(43) Pub. Date: Oct. 23, 2008

(54) Foam Rail Interlocking and Banding System

(75) Inventors: Gary M. Wahrmund, West Long Branch, NJ (US); James A. Warren, Bartonville, TX (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Sleep Innovations, Inc., West Long Branch, NJ (US)

(21) Appl. No.: 11/956,014

(22) Filed: Dec. 13, 2007

Related U.S. Application Data
(60) Provisional application No. 60/869,869, filed on Dec. 13, 2006.

(51) Int. Cl. A47C 31/00; F16B 1/00; A47C 27/08

(52) U.S. Cl. 5/706; 403/381; 5/738; 5/739

(57) ABSTRACT

Disclosed embodiments relate generally to the manufacture and assembly of mattresses, and comprise an interlocking system used to join foam support rails together to form a support frame about the perimeter of a mattress cover and/or a banding system for securing the support frame in place with respect to the mattress cover. The interlocking system generally comprises interlocking mechanical coupling portions at the ends of each support rail, allowing the ends of the support rails to be joined together to form a support frame without hard corner blocks that might reduce mattress comfort. The banding system comprises banding flaps that enwrap the support rails and attach them to the mattress cover. This allows for improved structural integrity during the assembly process, since the support frame is securely held in place.

### CROSS REFERENCE TO RELATED APPLICATIONS

This application claims priority benefit of U.S. provisional application No. 60/869,869, filed on Dec. 13, 2006, which is hereby incorporated by reference in its entirety.

### BACKGROUND OF THE INVENTION

### Field of the Invention

Disclosed embodiments relate generally to mattresses for bedding, and more specifically to methods and means for structuring foam rail support elements used to provide edge support and/or prevent damage to internal mattress components.

Air mattresses for standard bedding applications, such as those manufactured and sold by Select Comfort™, for example, are becoming an increasingly important segment of the mattress market. Such air mattresses use air chambers that provide cushioned support as users lie upon a bed, rather than the coils and springs associated with more traditional mattresses. The firmness of an air mattress may be adjusted based on the air pressure within the air chambers, allowing for easily customizable firmness. Indeed, if an air mattress includes more than one air chamber, firmness may be adjusted to vary across the mattress as desired (as for example, when the firmness on one side of the mattress is set to accommodate a first user, while the other side of the mattress is set in accordance with the firmness preferences of a second user).

Many air mattresses employ a design in which foam rails are positioned along the perimeter of the mattress, with the one or more air chambers located within the frame formed by the foam rails. The foam rails are typically joined together to form a single, unitary support frame about the perimeter of the mattress. These foam rails may serve to provide edge support for the mattress, while also acting to protect the air chambers from damage.

Conventionally, a corner block would be used at each corner of the mattress in order to join the foam rails into a unitary perimeter support frame. A typical corner block, as shown in FIG. 1, is an L-shaped bracket channel comprising two linear channels (each sufficiently wide to cradle a foam rail) positioned orthogonally. Each linear channel of the L-shaped corner block receives an end of one of the foam rails, with an end of a first foam rail being inserted into a first linear channel of the underlying corner block and an end of a second foam rail being inserted into a second linear channel of the underlying corner block. Thus, each corner block underlies the ends of two foam rails where they intersect to form a corner of the mattress. Often the corner block is formed of a rigid plastic, which must be sufficiently strong to lock the foam rails together to provide structural support for the edge of the mattress.

Because the plastic corner blocks are rigid, a disadvantage of mattresses formed with corner blocks joining perimeter foam rails together is hard and uncomfortable corners. Consumers tend to prefer softer corners that give, and therefore, some other means of joining together foam rails that support the edges of a mattress would be desirable.

An additional disadvantage of conventional foam rails (in relation to the mattress cover for the mattress) arises during the mattress assembly process. A mattress cover generally comprises an exterior cloth ticking used to contain the cushioned support layers of a mattress in order to form an integrated mattress unit. Generally, during the assembly process the mattress cover has the form of an open rectangular box, with a bottom and four sides connected to hold the interior elements of the mattress (such as the foam rails and the air chambers or coils and springs). It also generally includes a top flap, so that once all of the internal mattress components are properly positioned within the mattress cover, the top flap can be attached to close and complete the mattress.

Conventionally, the foam rails simply rest within the mattress cover and are not attached to the mattress cover. Problems may arise during the assembly process however, as the mattress cover is handled. Movement of the mattress cover during assembly may jostle the foam rails, and because the foam rails are not secured to the mattress cover, there may be offset movement that results in bent or buckled foam rails. In addition, due to the lack of fixed support within the mattress cover, it may shift into a non-rectangular shape, such that the air chambers might not fit properly within the mattress cover without an additional adjustment step. Thus, it may prove advantageous to employ some means for affixing the foam rails in place with respect to the mattress cover during the assembly process, as this would allow the foam rails to provide appropriate support for the mattress during the routine handling associated with assembly.

It should also be noted that air mattresses are relatively lightweight. Replacing the metal coils and springs of conventional mattresses with air chambers results in a mattress that is up to seventy-five percent lighter in weight. An unintended consequence of such lightweight air mattresses is that the mattresses may not rest securely atop a foundation support (such as a box spring), but may be prone to sliding or shifting about the foundation based merely on the type of movements typically associated with sleep. Thus, rather than relying simply on the weight of the air mattress to hold it securely atop a foundation, a need exists for a securing means.

These and other issues relating to mattress may be addressed by the embodiments of the foam rail interlocking and banding system disclosed herein.

### BRIEF SUMMARY OF THE INVENTION

The Foam Rail Interlocking and Banding System generally provides an improved mattress edge support frame system, with foam rails joined into a perimeter support frame without corner blocks that would make the corners of the mattress hard and uncomfortable, and with a banding system to secure the foam rails in place with respect to the mattress cover to provide support and structure during the assembly process. The Foam Rail Interlocking and Banding System generally employs foam support rails that interlock to form a unitary support frame for the perimeter of the mattress, along with some means for securing the support rails in place within the mattress cover.

In particular, the foam support rails are generally capable of an interlocking connection with one another by having compatible male and female coupling portions at each end. By fitting the male coupling portion of one support rail within the female coupling portion of another support rail, support rails may be interconnected securely. Typically, two side rails are interconnected with a head rail and a foot rail in order to form a unitary rectangular frame that defines and supports the perimeter edge of the mattress.

Additionally, the support rails forming the support frame for the mattress may be secured in place with respect to the mattress cover using a banding system. In general, flaps attached to the mattress cover may wrap around the support rails to securely hold the rails in place with respect to the mattress cover, providing structural integrity for the mattress cover during the assembly process. Once the flaps enwrap the support rails, such that the rails are snuggly held between the mattress cover and the banding flaps, the free end of the banding flaps can then be secured to the mattress cover so that the support rails may be securely held in place with respect to the mattress cover. The free end of the banding flaps may be either permanently or releasably secured to the mattress cover, depending upon the specific needs of the mattress. This banding system attaches the support frame rails to the mattress ticking, allowing the support rails to properly define and support the shape of the mattress throughout the assembly process.

The mattress may also be configured to include a non-slip liner on its bottom surface, in order to help prevent the mattress from slipping and sliding on the foundation. In an embodiment, a separate non-slip liner is attached to the portion of the mattress cover forming the bottom of the mattress. In another embodiment, the portion of the mattress cover forming the bottom of the mattress may be made of a non-slip material that acts as a non-slip liner. By using a material with sufficient gripping properties, a lightweight mattress may be secured atop its foundation to effectively prevent the mattress from sliding on the foundation.

Furthermore, the top of the mattress cover may contain a pocket, so that additional layers of cushioned support may be added to the mattress. Such a pocket on the top of the mattress cover would allow for easy installation of additional layers of cushioned support atop the basic, internal mattress cushioned support layers, allowing optional customization of the amount of cushioned support for a specific user's needs.

For mattress assembly, the mattress cover is opened and the foam support rails are placed inside the mattress cover along the perimeter. The support rails are joined via interlocking male/female coupling end portions to form a unitary support frame for the perimeter edge of the mattress. The banding flaps are then used to secure the support rails in place with respect to the mattress cover. Generally, the banding flaps are wrapped around the support rails in order to securely fasten them in place within the mattress cover. With the mattress cover now supported by the structural integrity of the rail support frame, the inner cushioned support layers are placed within the mattress cover, and the top of the mattress cover is then securely closed shut. If desired, additional cushioned support might optionally be added within a pocket located atop the mattress cover. In addition, a non-slip liner might be added to the bottom of the mattress cover.

The foam rail interlocking and banding system provides structural support for a mattress, while allowing the corners of the mattress to be soft and comfortable. With such a system, hard corner blocks are unnecessary, and the assembly process may be improved by securing a structural support frame within the mattress cover to prevent unwanted shifting and distortion of the mattress shape caused by movement and handling.

In one aspect, the present disclosure is directed to a device comprising a mattress cover comprising a bottom and four sidewalls and a plurality of banding flaps operable to securely fasten support rails to the mattress cover, with each support rail held flush against one of the sidewalls. The mattress cover may further comprise a non-slip liner on the underside of the bottom. In another embodiment, the mattress cover comprises a top flap having a pocket operable to contain one or more cushioned support layers. In an embodiment, one end of each banding flap is securely attached to the mattress cover, one end of each banding flap is releasably attached to the mattress cover, and each banding flap enwraps one of the support rails. In another embodiment, the device further comprises a plurality of support rails, each having interlocking end portions operable for mechanical coupling, wherein the support rails are mechanically coupled together to form a support frame extending about the inner perimeter of the mattress cover. The support rails may be mechanically coupled together using compatible male and female coupling end portions. In another embodiment, the male coupling end portions are L-shaped projections, and the female coupling end portions are corresponding L-shaped slots, such that the support rails are interlocked by slidably mating each male coupling end portion with a corresponding female coupling end portion. The support rails may comprise a head rail, a foot rail, and two side rails. In an embodiment, the head rail and the foot rail each comprise male coupling end portions at each end, and each of the side rails comprises female coupling end portions at each end. In yet another embodiment, the support rails are composed of foam.

In another aspect, the present disclosure is directed to a device comprising a mattress cover having a bottom, four sidewalls, and a top flap; four foam support rails, each having interlocking end portions; and four banding flaps, each operable to hold one of the support rails flush against a corresponding sidewall to securely fasten the support rails to the mattress cover. In an embodiment, each support rail substantially corresponds in length to one of the sidewalls. The four support rails may be joined together via the interlocking end portions to form a support frame extending about the inner perimeter of the mattress cover. In an embodiment, one end of each banding flap is securely attached to the mattress cover in proximity to the top of one of the sidewalls, each banding flap enwraps one of the support rails, and each banding flap releasably attaches to the bottom of the mattress cover. In an embodiment, the support rails are joined together using compatible male and female coupling end portions. The male coupling end portions may be L-shaped projections, and the female coupling end portions may be corresponding L-shaped slots, such that the support rails are interlocked by slidably mating each male coupling end portion with a corresponding female coupling end portion.

In yet another aspect, the present disclosure is directed to a device comprising a plurality of foam support rails, each having interlocking end portions wherein the support rails are mechanically coupled together to form a support frame extending about the inner perimeter of a mattress cover. In an embodiment, the support rails are mechanically coupled together using compatible male and female coupling end portions. The male coupling end portions may be L-shaped projections, and the female coupling end portions may be corresponding L-shaped slots, such that the support rails are interlocked by mating each male coupling end portion with a corresponding female coupling end portion.

In still another aspect, the present disclosure is directed to a method for assembling a mattress using a device of the type disclosed above, comprising placing support rails flush against the sidewalls of a mattress cover and securing the support rails in place with respect to the mattress cover using banding flaps. In an embodiment, the method further comprises interlocking the support rails together to form a support frame about the inside perimeter of the mattress cover. The support rails may be interlocked by slidably mating compatible male and female coupling end portions. In another embodiment, each of the support rails are secured to the mattress cover by wrapping one of the banding flaps around the support rail and releasably securing the banding flap to the mattress cover. The method may further comprise inserting one or more cushioned support layers into the mattress cover. In yet another embodiment, the method further comprises opening the top flap of the mattress cover, folding the banding flaps out of the mattress cover, closing the top flap of the mattress cover, and zipping the top flap shut to close the mattress cover.

In one aspect, an interlocking system for joining a plurality of foam support rails may comprise a first foam support rail having first and second ends, each with a coupling portion; a second foam support rail having first and second ends, each with a coupling portion; a third foam support rail having first and second ends, each with a coupling portion corresponding to one of coupling portions of the first foam support rail or the second foam support rail; and a fourth foam support railing having first and second ends, each with a coupling portion corresponding to one of the coupling portions of the first foam support rail or the second foam support rail. The first, second, third, and fourth foam support rails are joinable by interlocking the respective coupling portions to form a support frame such that the first and second foam support rails are opposite each other and the third and fourth foam support rails are opposite each other.

Further, the coupling portion of one of the first and second ends of each of the first, second, third, and fourth foam support rails may be a male coupling portion and the coupling portion of the other of the first and second ends of each of the first, second, third, and fourth foam support rails may be a female coupling portion.

Further still, the coupling portion of the first and second ends of each of the first and second foam support rails may be a male coupling portion and the coupling portion of the first and second ends of each of the third and fourth foam support rails may be a female coupling portion.

Further still, the first, second, third, and fourth foam support rails may be polyurethane foam.

Further still, the interlocking system may also comprise a bridge rail, having first and second ends, each with a coupling portion. The first foam support rail may have a coupling portion in a center region corresponding to the coupling portion of one of the first and second ends of the bridge rail and the second foam support rail may have a coupling portion in a center region corresponding to the coupling portion of the other of the first and second ends of the bridge rail such that the bridge rail is joinable with the support frame by interlocking the coupling portions of the bridge rail with the coupling portions in the center region of the first and second foam support rails.

Further still, the bridge rail may be foam.

In another aspect, a banding system for securing support rails in place may comprise a mattress cover that may comprise a surface having a plurality of edges; a plurality of sidewalls, one sidewall extending from each of the plurality of edges of the surface; and a plurality of banding flaps, each banding flap having a first end attached to one of the plurality of sidewalls and a second end secured to the surface such that each banding flap may secure a support rail in place between the banding flap, the sidewall to which the banding flap is attached, and the first surface.

Further, each sidewall may have a banding flap attached thereto.

Further still, the second end of the each banding flap may be removably secured to the surface.

Further still, the second end of each banding flap may have a strip of hook and loop tape and the surface may have a corresponding strip of hook and loop tape for securing the second end of each banding flap.

Further still, each sidewall may have a first end attached to the surface and a second end. The banding system may further comprise a cover having a size substantially the same as a size of the surface, wherein the cover may be securable to the second end of each of the sidewalls.

Further still, the cover may have a pocket for receiving cushioning.

Further still, the surface may have a first side from which the plurality of sidewalls extend and a second side. The banding system may further comprise a non-slip liner on the second side of the surface.

In yet another aspect, a mattress may comprise an interlocking system for joining a plurality of foam support rails, the interlocking system comprising a first foam support rail having first and second ends, each with a coupling portion; a second foam support rail having first and second ends, each with a coupling portion; a third foam support rail having first and second ends, each with a coupling portion corresponding to one of coupling portions of the first foam support rail or the second foam support rail; and a fourth foam support railing having first and second ends, each with a coupling portion corresponding to one of the coupling portions of the first foam support rail or the second foam support rail. The first, second, third, and fourth foam support rails are joinable by interlocking the respective coupling portions to form a support frame such that the first and second foam support rails are opposite each other and the third and fourth foam support rails are opposite each other. The mattress may also comprise a banding system for securing support rails in place, the banding system comprising a mattress cover comprising a surface having a first edge, a second edge, a third edge, and a fourth edge; a plurality of sidewalls, one sidewall extending from each of the first, second, third, and fourth edges of the surface; and a plurality of banding flaps, each banding flap having a first end attached to one of the plurality of sidewalls and a second end secured to the surface such that each banding flap may secure one of the first, second, third, and fourth foam support rails in place between the banding flap, the sidewall to which the banding flap is attached, and the surface. The support frame may have a perimeter that is substantially the same as the perimeter of the first surface of the mattress cover. each of the first, second, third, and fourth foam support rails may be secured by one of the plurality of banding flaps.

Further, the mattress may further comprise an air chamber located within the mattress cover.

Further, the interlocking system may further comprise a bridge rail, having first and second ends, each with a coupling portion. The first foam support rail may have a coupling portion in a center region corresponding to the coupling portion of one of the first and second ends of the bridge rail and the second foam support rail may have a coupling portion in a center region corresponding to the coupling portion of the other of the first and second ends of the bridge rail such that the bridge rail is joinable with the support frame by interlocking the coupling portions of the bridge rail with the coupling portions in the center region of the first and second foam support rails.

Further still, the second end of the each banding flap may be removably secured to the surface.

Further still, the second end of each banding flap may have a strip of hook and loop tape and the surface may have a corresponding strip of hook and loop tape for securing the second end of each banding flap.

Further still, each sidewall may have a first end attached to the surface and a second end, the system further comprising a cover having a size substantially the same as a size of the surface, wherein the cover may be securable to the second end of each of the sidewalls.

In still another aspect, a method of assembling a mattress may comprise providing a mattress cover comprising a surface having a first edge, a second edge, a third edge, and a fourth edge; a plurality of sidewalls, one sidewall extending from each of the first, second, third, and fourth edges of the surface; and a plurality of banding flaps, at least one for each sidewall, each banding flap having a first end attached to one of the plurality of sidewalls and a second end secured to the first surface such that each banding flap. The method may also comprise providing a first foam support rail having first and second ends, each with a coupling portion; providing a second foam support rail having first and second ends, each with a coupling portion; providing a third foam support rail having first and second ends, each with a coupling portion corresponding to one of coupling portions of the first foam support rail or the second foam support rail; providing a fourth foam support railing having first and second ends, each with a coupling portion corresponding to one of the coupling portions of the first foam support rail or the second foam support rail; joining the first, second, third, and fourth foam support rails to form a unitary support frame by interlocking the respective coupling portions such that the first and second foam support rails are opposite each other and the third and fourth foam support rails are opposite each other; placing the unitary support frame within the mattress cover; and securing each of the first, second, third, and fourth foam support rails to the mattress cover by attaching the second end of each banding flap to the first surface of the mattress cover.

Embodiments of the foam rail interlocking system are described in more detail below with the aid of reference figures.

### BRIEF DESCRIPTION OF THE DRAWINGS

For a more complete understanding of the present disclosure, and for further details and advantages thereof, reference is now made to the accompanying drawings, wherein:

FIG. 1 is a perspective drawing of a corner block of the type conventionally used to join foam support rails to form the frame for the perimeter edge of a mattress;

FIG. 2 is a top plan view of an interlocking support frame formed by joining foam support rails, along with a foam bridge;

FIG. 3 is a perspective drawing of an open mattress cover with banding flaps; and

FIG. 4 is a blown-apart perspective process flow diagram illustrating an assembly process method using a foam interlocking rail and a banding system.

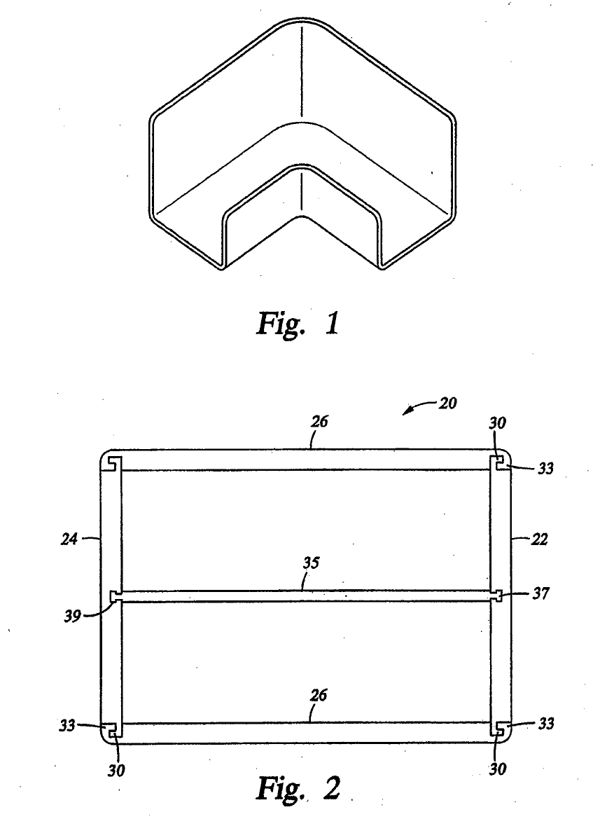

### DETAILED DESCRIPTION OF THE INVENTION

The foam rail interlocking and banding system comprises an interlocking system for joining support rails, allowing a plurality of support rails to be securely coupled into an integrated, unitary perimeter support frame for a mattress, and a banding system, allowing support rails to be held firmly in place with respect to the mattress cover in order to maintain proper positioning and alignment of the mattress cover throughout the assembly process. By jointly employing an interlocking system and a banding system, the support frame may effectively provide structural integrity for the mattress, defining the perimeter of the mattress and protecting the cushioned support layers disposed therein from damage.

An interlocking system allows the support rails to be joined into a unitary support frame without the need for corner blocks. Instead, each support rail includes integrated interlocking coupling portions that work together to allow rails to be mechanically joined, forming the support frame for the mattress along the inner perimeter of the mattress cover. Such a support frame includes interlocking corners. Generally, compatible male and female coupling portions are located at the ends of the support rails, allowing the ends of the rails to be joined. Such support rails might be joined by fitting a male coupling end portion associated with one support rail within a corresponding female coupling end portion associated with another support rail.

FIG. 2 illustrates such an interlocking system with four support rails, a head rail 22, a foot rail 24, and two side rails 26. Each of the support rails has either a compatible male or female coupling portion at each end. For example, the head rail 22 and the foot rail 24 each have a male coupling portion 30 at each end, while each of the side rails 26 has a compatible female coupling portion 33 at each end. In FIG. 2, the male coupling end portions 30 are substantially L-shaped, and the female coupling end portions 33 are correspondingly L-shaped for compatible mating with the male coupling end portions 30. Thus, a hooking mechanical joint is formed between support rails when a male coupling end portion 30 on one support rail is slidably inserted into a corresponding female coupling end portion 33 on another support rail. For instance, in FIG. 2 the male coupling end portions 30 on both ends of the head rail 22 would be inserted into corresponding female coupling end portions 33 on the two side rails 26 (with one side rail extending from each end of the head rail 22). Likewise, the male coupling end portions 30 on both ends of the foot rail 24 would be inserted into the remaining female coupling end portions 33 on the two side rails 26. In this way, the support rails of FIG. 2 are joined into a rectangular perimeter support frame 20. Each support rail in FIG. 2 has matching coupling portions on each end, but this is not required; each support rail could instead have a male coupling portion at one end and a female coupling portion at the other end. In the embodiment depicted in FIG. 2, all of the coupling portions are L-shaped, but other interlocking coupling portion shapes could be used instead, such as C-shaped coupling portions, for example. Likewise, a mixture of different coupling portion shapes could be used to form the corners of the support frame 20.

The support rails forming the support frame 20 of FIG. 2 are generally composed of foam, typically polyurethane foam. The frictional coefficient of foam in contact with foam is quite high. Thus, the mechanical coupling portions linking two support rails together to form a corner of the system 20 may be enhanced by the frictional properties of the foam support rails, with the L-shaped mechanical coupling portions providing for increased contact surface area between the support rails so that a frictional bond may strengthen the joint. Nevertheless, alternative materials may be used for the support rails.

FIG. 2 further illustrates a foam support frame 20 having an interconnecting central foam bridge 35 extending between the head rail 22 and the foot rail 24 substantially along the centerline of the support frame 20 (such that the center of the head rail 22 is connected to the center of the foot rail 24 via foam bridge 35). It may be useful to incorporate a foam bridge 35 if the mattress will include two air chambers, since the foam bridge 35 may separate the air chambers and prevent them from rubbing against one another, which could make noise and/or damage the air chambers. In addition, the foam bridge 35 may provide additional structural support to the support frame 20, acting as a brace. In FIG. 2, the foam bridge 35 has T-shaped coupling portions 37 located at each end, which are compatible with corresponding T-shaped slots 39 located along the centerline of both the head rail 22 and the foot rail 24. Thus, the foam bridge 35 may be securely joined to both the head rail 22 and the foot rail 24 by sliding the T-shaped coupling portion 37 into the corresponding slots 39.

FIG. 2 illustrates only one specific embodiment of the interlocking system, and is not intended to limit the general scope of the interlocking system. Persons skilled in the art field will appreciate and understand alternative configurations and equivalents, all of which are included within the disclosed interlocking system. By way of non-exclusive example, various types of integrated mechanical coupling portions may be used for joining support rails into a support frame 20, and alternative configurations of the coupling portions with respect to the support rails may be feasible. Similarly, the support rails may be made of foam, such as polyurethane foam, or of other appropriate materials which may provide support and structural integrity, while also providing a sufficiently cushioned feel.

A banding system allows the support rails to be held in place within a mattress cover, providing effective support along the inner perimeter of the mattress cover. Generally, a mattress cover comprises a substantially rectangular bottom and four sidewalls, extending up from the bottom to form an open box. The mattress cover also generally includes a top flap, which may be opened to allow for insertion of cushioned support layers during assembly, or closed and fastened to form the top of the mattress (so that the mattress cover completely encloses the cushioned support layers to form a substantially rectangular mattress). A banding system generally comprises banding flaps, with one or more flaps for each sidewall of the mattress. The banding flaps hold the support rails in place inside the mattress cover, with each flap enwrapping one or more of the support rails and attaching to the mattress cover to firmly hold the support rails in place along the inner perimeter of the mattress cover.

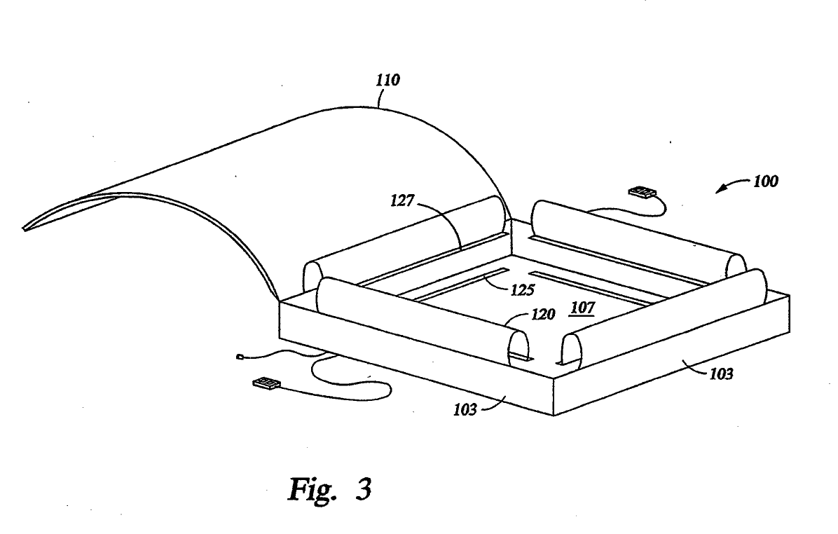

FIG. 3 shows an embodiment of a mattress cover 100 with four banding flaps 120. As depicted in FIG. 3, one banding flap 120 is securely attached to each sidewall 103 of the mattress cover 100, with one end of each banding flap 120 attached near the top edge of the sidewall 103. The banding flaps 120 are each sized to enwrap a single support rail (placed flush against the sidewall 103) by snuggly fitting across the upper surface of the support rail and down the inner surface of the support rail. Thus, the banding flap 120 allows for a support rail to be firmly held in place between the banding flap 120, the sidewall 103, and the bottom 107 of the mattress cover 100. A means for attaching another end of the banding flap 120 to the mattress cover bottom 107 is also provided. The banding flap 120 may be releasably attached to the bottom 107 of the mattress cover 100 using various means, including a hook and loop tape, such as VELCRO™. For each flap 120 in FIG. 3, a strip of hook and loop tape 125 is affixed to the mattress cover bottom 107 (spaced approximately the width of a support rail away from the sidewall 103), while a corresponding hook and loop tape strip 127 is affixed to the end of the banding flap 120 furthest from the sidewall 103 (and opposite the end of the banding flap 120 attached to the sidewall).

To assemble a support frame system, such as the system 20 of FIG. 2, into the mattress cover 100 of FIG. 3, a support rail (generally composed of foam) would be placed within the mattress cover 100 along each sidewall 103, forming a perimeter support frame 20 for the mattress. If an interlocking system is used, the support rails 22, 24, 26 would be interlocked by coupling the mechanical coupling portions 30, 33 integrated into the ends of the support rails 22, 24, 26. With the support rails 22, 24, 26 in place within the mattress cover 100 and interconnected, the banding flaps 120 would be extended down to enwrap the support rails and releasably attach to the mattress cover bottom 107, with the hook and loop tape strip 127 on the flap 120 mating with the hook and loop tape strip 125 on the bottom 107. Thus, each support rail would be firmly held in place against a sidewall 103 by the appropriate banding flap 120, which snuggly enwraps the support rail and releasably attaches it to the mattress cover 100.

In FIG. 3, each banding flap 120 is securely fastened to the top edge of its sidewall 103 along the inside of the sidewall 103. This positioning of the interconnection between the banding flap 120 and the mattress cover 100 ensures that no portion of the flaps 120 are visible once the mattress cover 100 is closed, improving the aesthetics of the final mattress product. Additionally, this positioning ensures that the top flap 110 of the mattress cover 100 can be closed and sealed easily. This is particularly important if, as in FIG. 3, the mattress cover 100 uses one or more zippers to secure the top flap 110 to the sidewalls 103.

FIG. 3 illustrates only one specific embodiment of the banding system, and is not intended to limit the general scope of the banding system. Persons skilled in the art field will appreciate and understand alternative configurations and equivalents, all of which are included within the disclosed banding system. By way of non-exclusive example, the location and number of banding flaps 120 may be altered, or the means of attaching the banding flaps 120 to the mattress cover 100 could involve substitutions such as snaps, zippers, adhesive, or sewing, without altering the overall banding system. Similarly, the top flap 110 could be fastened to the sidewalls 103 by sewing or some other attachment means, rather than using the zippered connection shown in FIG. 3.

The banding system may aid in the mattress assembly process by securely holding the support frame 20 in place with respect to the mattress cover 100, thereby preventing shifting that might occur during the normal handling associated with mattress assembly. When used in conjunction with the interlocking system, the mattress cover 100 may also be given structural integrity for the assembly process.

Mattress assembly using the foam rail interlocking and banding system begins by inserting support rails 22, 24, 26 into place within the open mattress cover 100, with each support rail flush against a sidewall 103 of the mattress cover 100. The support rails 22, 24, 26 may then be interlocked via the connecting portions 30, 33 to form a unitary support frame 20 about the inner perimeter of the mattress cover 100. Banding flaps 120 would then enwrap each support rail and attach to the bottom 107 of the mattress cover 100, thereby holding the support rails 22, 24, 26 securely in place with respect to the mattress cover 100. With the support frame 20 securely fastened within the mattress cover 100, cushioned support layers (by way of non-exclusive example, air chambers, foam, water chambers, and/or coil springs) would be added to the mattress cover 100 and placed within the open space bordered by the support frame 20. With all of the internal components of the mattress in place, the top flap 110 of the mattress cover 100 would be closed and secured, creating the finished mattress product.

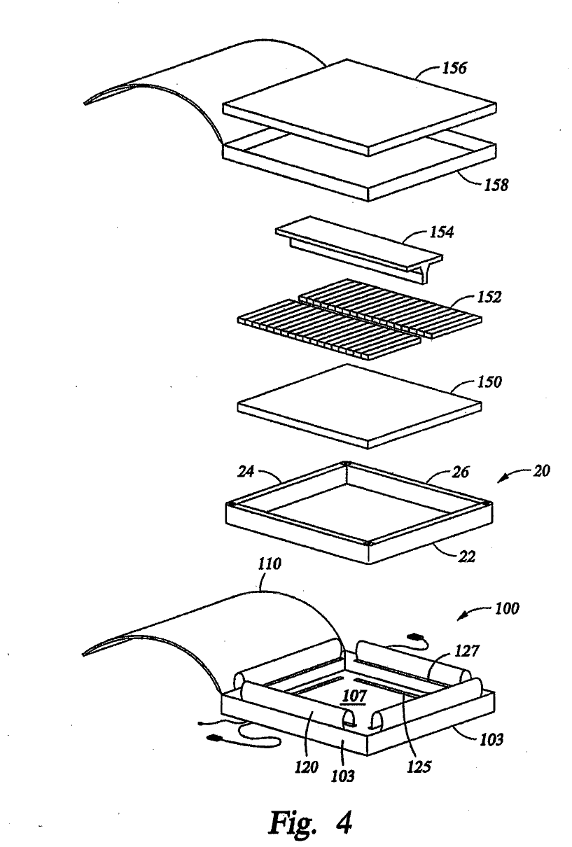

FIG. 4 depicts an embodiment of mattress components that may be assembled by such a mattress assembly process. The lowermost component depicted is an open mattress cover 100 with the top flap 110 folded back. If necessary, the banding flaps 120 would also be folded back to hang outside of the mattress cover 100 such that they may not intrude into the space within the mattress cover 100. A support rail frame 20 is shown directly above the open the mattress cover 100 and would be inserted into the mattress cover 100 along its inner perimeter adjacent sidewalls 103. In particular, as shown in FIG. 4, a head rail 22, a foot rail 24, and two matching side rails 26 would be placed flush along the corresponding perimeter edges of the mattress cover 100. The support rails 22, 24, 26 are shown interlocked into a unitary, substantially rectangular support frame 20, which is accomplished by matably sliding male coupling portions 30 at the ends of the head rail 22 and the foot rail 24 into the compatible female coupling portions 33 at the ends of both side rails 26 as previously described with respect to FIG. 2.

With the support frame 20 assembled and in place within the mattress cover 100 of FIG. 4, the banding flaps 120 would each be pulled down around their associated support rails, to enwrap each support rail and firmly hold it in place flush against the sidewall 103. Each banding flap 120 would then be releasably secured to the mattress cover bottom 107, with matching hook and loop tape strips 127 on the flaps 120 mating with corresponding strips 125 on the bottom 107. Thus, the support frame 20 would be held snuggly in place within the mattress cover 100 by the banding system.

Cushioned support layers would then be inserted into the mattress cover. In FIG. 4, a bottom layer 150 is shown directly above the support frame 20. This bottom layer 150, that may be generally composed of conventional foam, for example, may be installed to line the bottom 107 of the mattress cover 100 within the support frame 20. The mattress shown in FIG. 4 utilizes two air chambers 152, which are depicted directly above the bottom layer 150. These two air chambers 152 provide two separate zones in the mattress wherein the level of support may be adjusted for individual user preferences. The air chambers 152 may be inserted to rest atop the conventional foam bottom layer 150 within the support frame 20 in the mattress cover 100. The air chambers 152 may also be separated by a foam bridge 154 that extends therebetween. The foam bridge 154 may include coupling portions at each end that mate with corresponding slots in the head rail 22 and the foot rail 24 as well. Finally, the uppermost component depicted in FIG. 4 is a topper layer 156 that may generally comprise visco foam, for example. This topper layer 156 may be placed directly atop the air chambers 152 within the mattress cover 100. Alternatively, this topper layer 156 may be placed within its own cover 158 within the mattress cover 100, in order to protect the visco foam material.

Once all of the internal mattress components have been placed within the mattress cover 100, the top flap 110 of the mattress cover 100 can then be closed and secured shut. In an embodiment, the top flap 110 is removeably fastened to the sidewalls 103. In FIG. 4 for example, the top flap 110 and the sidewalls 103 include corresponding zippers, allowing the top flap 110 to be zippered shut to complete the mattress. Such a removably fastened top flap 110 is especially useful if the mattress will be shipped to the consumer, since it may allow for mattress assembly upon delivery. Alternatively, the top flap 110 could be sewn shut to form a permanently sealed mattress.

Additionally, the top flap 110 of the mattress may optionally include a pocket for holding additional layers of cushioned support. This allows for easy installation of additional layers of cushioned support in order to customize the mattress according to a specific customer's wishes. Cushioned support may be installed within the pocket at the time of initial assembly, or it may be added later as an upgrade.

Optionally, it may be useful for the mattress to include a non-slip liner, especially if the mattress uses lightweight air chambers 152. The non-slip liner could either be a separate element attached to the underside of the bottom 107 of the mattress cover 100, or it could be formed by the mattress cover bottom 107 itself being made of a non-slip material. Such a non-slip liner would generally have material properties that resist slippage (for example, a material with a sufficiently high coefficient of friction with respect to the foundation on which the mattress will lie, to prevent shifting of the mattress during its ordinary use).

While various embodiments of the foam rail interlocking and banding system and associated methods have been shown and described herein, modifications thereof may be made by one skilled in the art without departing from the spirit and the teachings of the disclosure. The embodiments described herein are exemplary only and are not intended to be limiting. Many variations, combinations, and modifications are possible and are within the scope of the disclosure. Accordingly, the scope of protection is not limited by the description set out above, but is defined by the claims which follow, that scope including all equivalents of the subject matter of the claims.

What is claimed is:

1. An interlocking system for joining a plurality of foam support rails, the system comprising:
a first foam support rail having first and second ends, each with a coupling portion;
a second foam support rail having first and second ends, each with a coupling portion;
a third foam support rail having first and second ends, each with a coupling portion corresponding to one of coupling portions of the first foam support rail or the second foam support rail; and
a fourth foam support railing having first and second ends, each with a coupling portion corresponding to one of the coupling portions of the first foam support rail or the second foam support rail;
wherein the first, second, third, and fourth foam support rails are joinable by interlocking the respective coupling portions to form a support frame such that the first and second foam support rails are opposite each other and the third and fourth foam support rails are opposite each other.

2. The interlocking system of claim 1, wherein the coupling portion of one of the first and second ends of each of the first, second, third, and fourth foam support rails is a male coupling portion and the coupling portion of the other of the first and second ends of each of the first, second, third, and fourth foam support rails is a female coupling portion.

3. The interlocking system of claim 1, wherein the coupling portion of the first and second ends of each of the first and second foam support rails is a male coupling portion and the coupling portion of the first and second ends of each of the third and fourth foam support rails is a female coupling portion.

4. The interlocking system of claim 1, wherein the first, second, third, and fourth foam support rails are polyurethane foam.

5. The interlocking system of claim 1, further comprising:
a bridge rail, having first and second ends, each with a coupling portion;
wherein the first foam support rail has a coupling portion in a center region corresponding to the coupling portion of one of the first and second ends of the bridge rail and the second foam support rail has a coupling portion in a center region corresponding to the coupling portion of the other of the first and second ends of the bridge rail such that the bridge rail is joinable with the support frame by interlocking the coupling portions of the bridge rail with the coupling portions in the center region of the first and second foam support rails.

6. The interlocking system of claim 5, wherein the bridge rail is foam.

7. A banding system for securing support rails in place, the system comprising:
a mattress cover comprising:
a surface having a plurality of edges;
a plurality of sidewalls, one sidewall extending from each of the plurality of edges of the surface; and
a plurality of banding flaps, each banding flap having a first end attached to one of the plurality of sidewalls and a second end secured to the surface such that each banding flap may secure a support rail in place between the banding flap, the sidewall to which the banding flap is attached, and the first surface.

8. The banding system of claim 7, wherein each sidewall has a banding flap attached thereto.

9. The banding system of claim 7, wherein the second end of the each banding flap is removably secured to the surface.

10. The banding system of claim 9, wherein the second end of each banding flap has a strip of hook and loop tape and the surface has a corresponding strip of hook and loop tape for securing the second end of each banding flap.

11. The banding system of claim 7, wherein each sidewall has a first end attached to the surface and a second end, the system further comprising a cover having a size substantially the same as a size of the surface, wherein the cover is securable to the second end of each of the sidewalls.

12. The banding system of claim 11, wherein the cover has a pocket for receiving cushioning.

13. The banding system of claim 7, wherein the surface has a first side from which the plurality of sidewalls extend and a second side, the system further comprising a non-slip liner on the second side of the surface.

14. A mattress, comprising:
an interlocking system for joining a plurality of foam support rails, the interlocking system comprising:
a first foam support rail having first and second ends, each with a coupling portion;
a second foam support rail having first and second ends, each with a coupling portion;
a third foam support rail having first and second ends, each with a coupling portion corresponding to one of coupling portions of the first foam support rail or the second foam support rail; and
a fourth foam support railing having first and second ends, each with a coupling portion corresponding to one of the coupling portions of the first foam support rail or the second foam support rail;
wherein the first, second, third, and fourth foam support rails are joinable by interlocking the respective coupling portions to form a support frame such that the first and second foam support rails are opposite each other and the third and fourth foam support rails are opposite each other; and
a banding system for securing support rails in place, the banding system comprising:
a mattress cover comprising:
a surface having a first edge, a second edge, a third edge, and a fourth edge;
a plurality of sidewalls, one sidewall extending from each of the first, second, third, and fourth edges of the surface; and
a plurality of banding flaps, each banding flap having a first end attached to one of the plurality of sidewalls and a second end secured to the surface such that each banding flap may secure one of the first, second, third, and fourth foam support rails in place between the banding flap, the sidewall to which the banding flap is attached, and the surface;
wherein the support frame has a perimeter that is substantially the same as the perimeter of the first surface of the mattress cover and wherein each of the first, second, third, and fourth foam support rails are secured by one of the plurality of banding flaps.

15. The mattress of claim 14, further comprising an air chamber located within the mattress cover.

16. The mattress of claim 14, wherein the interlocking system further comprises:
a bridge rail, having first and second ends, each with a coupling portion;
wherein the first foam support rail has a coupling portion in a center region corresponding to the coupling portion of one of the first and second ends of the bridge rail and the second foam support rail has a coupling portion in a center region corresponding to the coupling portion of the other of the first and second ends of the bridge rail such that the bridge rail is joinable with the support frame by interlocking the coupling portions of the bridge rail with the coupling portions in the center region of the first and second foam support rails.

17. The mattress of claim 14, wherein the second end of the each banding flap is removably secured to the surface.

18. The mattress of claim 17, wherein the second end of each banding flap has a strip of hook and loop tape and the surface has a corresponding strip of hook and loop tape for securing the second end of each banding flap.

19. The mattress of claim 14, wherein each sidewall has a first end attached to the surface and a second end, the system further comprising a cover having a size substantially the same as a size of the surface, wherein the cover is securable to the second end of each of the sidewalls.

20. A method of assembling a mattress, the method comprising:
providing a mattress cover comprising:
a surface having a first edge, a second edge, a third edge, and a fourth edge;
a plurality of sidewalls, one sidewall extending from each of the first, second, third, and fourth edges of the surface; and
a plurality of banding flaps, at least one for each sidewall, each banding flap having a first end attached to one of the plurality of sidewalls and a second end secured to the first surface such that each banding flap;
providing a first foam support rail having first and second ends, each with a coupling portion;
providing a second foam support rail having first and second ends, each with a coupling portion;
providing a third foam support rail having first and second ends, each with a coupling portion corresponding to one of coupling portions of the first foam support rail or the second foam support rail;
providing a fourth foam support railing having first and second ends, each with a coupling portion corresponding to one of the coupling portions of the first foam support rail or the second foam support rail;
joining the first, second, third, and fourth foam support rails to form a unitary support frame by interlocking the respective coupling portions such that the first and second foam support rails are opposite each other and the third and fourth foam support rails are opposite each other;
placing the unitary support frame within the mattress cover; and
securing each of the first, second, third, and fourth foam support rails to the mattress cover by attaching the second end of each banding flap to the first surface of the mattress cover.
